(19) United States
(12) Patent Application Publication
(10) Pub. No.: US 2003/0063194 A1
(43) Pub. Date: Apr. 3, 2003

(54) Photography supporting system and photography supporting server

(76) Inventors: Akio Nishiyama, Asaka-shi (JP); Tomoyuki Koshio, Yokohama-shi (JP)

Correspondence Address: BIRCH STEWART KOLASCH & BIRCH, PO BOX 747, FALLS CHURCH, VA, 22040-0747, US

(21) Appl. No.: 10/256,074

(22) Filed: Sep. 27, 2002

(30) Foreign Application Priority Data
Sep. 28, 2001 (JP) P2001-302302

(51) Int. Cl. H04N 5/225

(52) U.S. Cl. 348/207.1

(57) ABSTRACT

A photography supporting system is provided, while the photography supporting system is capable of performing photograph supporting operations of plural locations or objections as a gamely recreation. The system includes a photography supporting server connected to the communication line and a portable terminal, which is connectable to a digital camera and capable of transmitting/receiving information via the communication line with respect to the photography supporting server. The server transmits photography supporting information to the portable terminal in order to instruct a user to shoot a photograph of a designated object. By receiving/transmitting necessary information for this service between the server and the portable terminal, a user can easily obtain edited images by using photographs shot by himself with a digital camera. The edited image includes shot image information of the photograph, hint information indirectly indicates location information or object information, or such.

### BACKGROUND OF THE INVENTION

1. Field of the Invention

The present invention is related to a photography supporting system for performing a photograph supporting operation by utilizing photography supporting information transmitted via a communication line, and also related to a photography supporting server for transmitting the photography supporting information.

2. Description of the Related Art

While cameras are made in light weight, compact, and can be operated in simple manners, photographing operations are simply and easily carried out in sightseeing spots, so-called “Theme-parks”, and zoogical gardens. However, there are many opportunities that photographers perform photographing operations without having information as to photograph points, photograph time, and the like. Therefore, satisfactable photographed images cannot be always acquired. To obtain such satisfactable images, photographers need gasp in advance such information as sightseeing spots by reading books, or the like. However, it is not simple to properly acquire the necessary information in advance, but also the acquired information does not always reflect the latest information.

Since portable terminals such as portable telephones are popularized, such information services that information as to sightseeing spots is provided to portable telephones have been practically realized. However, these information services merely introduce outlines of these sightseeing spots, but are not provided so as to perform photograph supporting operations by cameras, for instance, photograph points and photographing subjects. Also, the information provided by these information services merely introduces only points of desirable information. Moreover, these information services merely introduce typical transport routes which are out of interest for users.

As a system capable of providing information related to both photographing subjects and photographing operations, Japanese Laid-open Patent Application No. Hei-9-233465 describes “GUIDE PHOTOGRAPH SYSTEM.” This system basically performs the photographing operations in the sightseeing spot by employing both the terminal apparatus and the photographing means, which are installed in this sightseeing spot. However, this system is not directed to such photographing operations executed by using cameras owned by users. Also, in this guide photograph system, photographing operations executed in conjunction with plural places cannot be performed, but also, edited images which are produced by editing images photographed at plural places cannot be acquired.

As a system for editing images photographed at plural places, Japanese Laid-open Patent Application No. Hei-10-181241 describes “PERSONAL TRAVEL ALBUM FORMING SYSTEM.” In this system, when the photographing operation is carried out, the photograph point information is automatically recorded in combination with the image information, the area map covering this photograph point is automatically outputted, and the photographed image is automatically layout-processed at the photograph point on the area map, so that the layout-processed image is outputted. However, in order to edit a plurality of images, such a camera containing a position detecting means should be utilized. Moreover, since the images photographed at preselected points are edited, the resulting edited images may become uniform images in this system. Also, since the editing process operation is carried out after the photographing operations have been accomplished, the edited images cannot be acquired within a short time.

### SUMMARY OF THE INVENTION

The present invention has been made to solve the above-described problems, and has an object to provide such a photography supporting system capable of performing a photograph supporting operation as to either a plurality of photograph points or a plurality of photographing subjects, while adding thereto game natures. Also, the present invention is to provide a photography supporting system capable of simply acquiring an edited image from a plurality of photographed images within a short time.

A photography supporting system, according to the present invention, is featured by such a photography supporting system for executing a photograph supporting operation by utilizing photography supporting information transmitted via a communication line, comprising: a photography supporting server connected to the communication line; and a portable terminal connectable to a digital camera, capable of transmitting/receiving information via the communication line with respect to the photography supporting server; wherein: the photography supporting information contains at least one of shooting location instructing information and shooting object instructing information; the photography supporting server transmits the shooting object instructing information to the portable terminal; the portable terminal transmits image specifying information which specifies an image photographed by the digital camera to the photography supporting server; the transmission of the photography supporting information by the photography supporting server is carried out when a transmission request is issued from the portable terminal, or the image specifying information is received; and the image specifying information transmitted by the portable terminal is obtained from the digital camera connected to the portable terminal. In accordance with this photography supporting system, since the photography supporting information is sequentially transmitted to the portable terminal, the user of the portable terminal can enjoy the photographing operations to which the game nature is added.

As the above-described image specifying information in the photography supporting system of the present invention, either shot image information photographed by the digital camera, or supplemental information of shot image information photographed by the digital camera is utilized. Also, in the case that the supplemental information is utilized as the above-described image specifying information, photograph point information is contained in the supplemental information.

The above-described portable terminal in the photography supporting system of the present invention owns a position detecting function, and when the portable terminal transmits the image specifying information to the photograph supporting sever, the portable terminal transmits the image specifying information in combination with positional information acquired by the position detecting function.

In the photography supporting system of the present invention, while communication apparatus are furthermore installed at a plurality of places within a photograph area where photographing operation is carried out based upon the photography supporting information, the communication apparatus sense presence of either the portable terminal or the digital camera, and transmit a presence sensing signal to the photography supporting server when presence of the portable terminal, or the digital camera is sensed; the photography supporting server transmits the photography supporting information to the portable terminal when the photography supporting server receives both the image specifying information and the presence sensing signal. As a consequence, since the photography supporting system can confirm as to whether the transmitted information corresponds to the image specifying information transmitted from the portable terminal; or the information which is acquired at the photographing place based upon the photography supporting information, the game nature thereof can be furthermore improved.

The photography supporting system of the present invention is further comprised of an image editing device for editing shot image information which is photographed based upon the photography supporting information; and wherein: the image editing device edits information which contains shooting location instructing information contained in the photography supporting information, image information related to the shooting object instructing information, or text information.

Also, the above-described edited image in the photography supporting system of the present invention corresponds to such an image produced by that the image obtained based upon the photographed image information is mapped at a position corresponding to the photography supporting information and as to an area map of the photograph area where the photographing operation is carried out based upon the photography supporting information.

Also, the above-described photography supporting information in the photography supporting system of the present invention corresponds to hint information which indirectly indicates either a photograph point or a photographing subject; and the edited image obtained by the image editing device corresponds to an image which contains information indicative of either the photograph point or the photographing subject based upon the hint information.

The above-described photography supporting server in the photography supporting system of the present invention may function also as the above-explained image editing device. In accordance with this system, the structure of this photography supporting server can be made simple, and since the image information is employed as the image specifying information, the edited image can be acquired in a more simple manner.

A photography supporting server of the present invention is featured by such a photography supporting server for transmitting photography supporting information via a communication line to a portable terminal, wherein: the portable terminal is connectable to a digital camera; the photography supporting information contains at least one of shooting location instructing information and shooting object instructing information; and the photography supporting server transmits the photography supporting information to the portable terminal when the photography supporting server receives a photography supporting information transmission request issued from the portable terminal, or when the photography supporting server receives image specifying information via the portable terminal, while the image specifying information specifies a photographed image which is obtained from the digital camera.

As the above-described image specifying information in the photography supporting server of the present invention, either photographed image information photographed by the digital camera, or supplemental information of the photographed image information photographed by the digital camera may be used. Also, in the case that the supplemental information is utilized as the image specifying information, photograph point information is contained in the additional information.

The above-explained portable terminal in the photography supporting server of the present invention owns a position detecting function; and the portable terminal receives positional information obtained by the position detecting function in combination with the image specifying information.

The photography supporting server of the present invention transmits to the portable terminal, both the photography supporting information and presence sensing signals when the image specifying information is received, while the presence sensing signals are transmitted from communication apparatus which are installed at a plurality of places within a photograph area where photographing operation is carried out based upon the photography supporting information, and owns a function- capable of sensing presence of either the portable terminal or the digital camera. As a consequence, since the photography supporting server can confirm as to whether the transmitted information corresponds to the image specifying information transmitted from the portable terminal, or the information which is acquired at the photographing place based upon the photography supporting information, the game nature thereof can be furthermore improved.

The photography supporting server of the present invention owns an image editing function for editing photographed image information which is photographed based upon the photography supporting information; and wherein: the edited image obtained by the image editing function corresponds to an image which contains shooting location instructing information contained in the photography supporting information, image information related to the shooting object instructing information, or text information.

Also, the above-described edited image in the photography supporting server of the present invention corresponds to such an image produced by that the image obtained based upon the photographed image information is mapped at a position corresponding to the photography supporting information and as to an area map of the photograph area where the photographing operation is carried out based upon the photography supporting information.

Also, the above-explained photography supporting information in the photography supporting server of the present invention corresponds to hint information which indirectly indicates either a photograph point or a photographing subject; and the edited image corresponds to an image which contains information indicative of either the photograph point or the photographing subject based upon the hint information.

### BRIEF DESCRIPTION OF THE DRAWINGS

FIG. 1 is a diagram for schematically showing an arrangement of a photography supporting system according to an embodiment mode of the present invention,

FIG. 2 is a flow chart for schematically explaining operations executed when photographing operation is carried out by using the photography supporting system,

FIG. 3 is a block diagram showing an example of a photography supporting server according to an embodiment of the present invention, and

FIG. 4 is a block diagram showing another example of a photography supporting server according to another embodiment of the present invention.

In the figures, the reference numeral1 refers to a photography supporting server; 2 to a portable terminal; 3 to a digital camera; 4 to a communication device; 5 to an image editing device; 6 to a printer; 101 to a receiving section; 102 to a transmitting section; 103 to an image editing section; and 104 to a registering section.

### DETAILED DESCRIPTION OF THE PREFERRED EMBODIMENTS

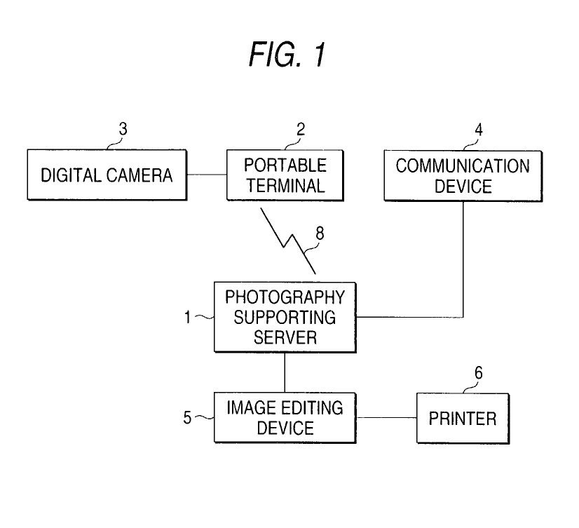

Referring now to the drawings, embodiments of the present invention will be described. FIG. 1 is a diagram for schematically indicating an arrangement of a photography supporting system according to an embodiment mode of the present invention. The photography supporting system in FIG. 1 includes a photography supporting server 1, a portable terminal 2, a digital camera 3, a communication device 4, an image editing device 5, and a printer 6.

The photography supporting server 1 transmits/receives information via a communication line 8 with respect to the portable terminal 2. The photography supporting server 1 transmits photography supporting information to the portable terminal 2, and receives image specifying information from the portable terminal 2. The image specifying information may specify a photograph shot by the digital camera 3. Then, the photography supporting server 1 transmits the image specifying information to an image editing device. The photography supporting information includes at least one of shooting location instructing information and shooting object instructing information. The shooting location instructing information and the shooting object instruction information are used to instruct a shooting location and a shooting object respectively, and the shooting location and the shooting object exist within a photography supporting area such as a sightseeing spot, a so-called “Theme-park”, and a zoogical garden. It should be noted that both a shooting location and a shooting object are need not always, directly to be designated by a name of place, a name of object, or such. Instead of the names, the shooting location and the shooting object maybe indirectly designated by hint information. Alternatively, as the image specifying information, shot image information itself of a photograph shot by the digital camera 3 may be employed, and/or supplemental information may also be employed. The term of “supplemental information” in this invention is a complementary information included in the shot image information and has information of a situation of the shot photograph, for example, information of a place where the photo is shot, a date/time when the photo is shot, or such. In the case that the digital camera 3 includes a position detecting section for obtaining positional information, namely shooting location information, the positional information may be preferably added to the supplemental information by detecting where the digital camera 3 is located.

As described above, the shot image information includes an image itself of a shot photograph and supplemental information having location information, date/time information, or such.

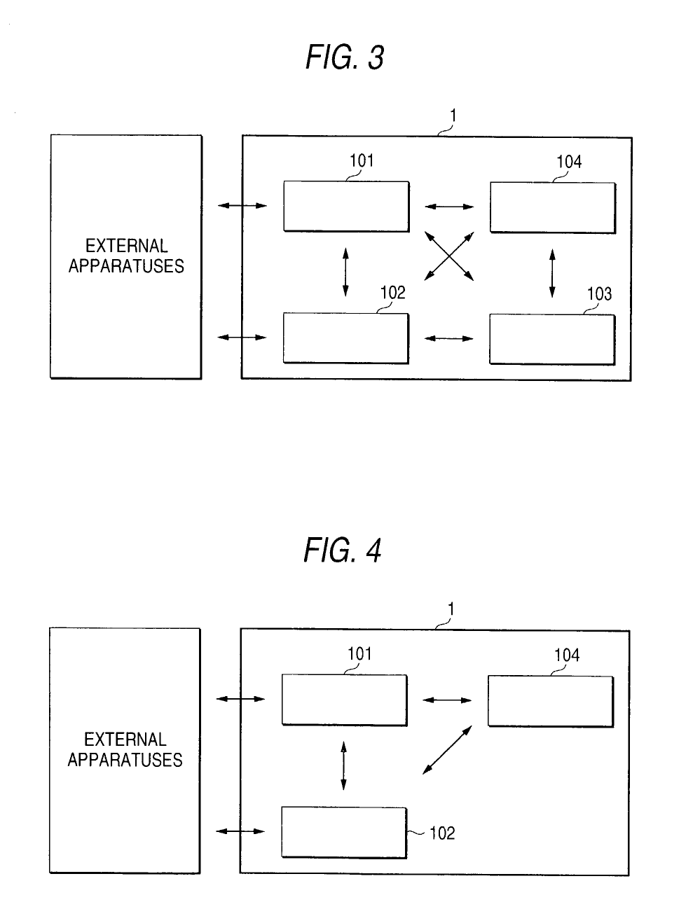

As shown in FIG. 3, the photography supporting server 1 includes a receiving section 101 for receiving information such like requests, presence sensing signals, or the like from external apparatuses, a transmitting section 102 for transmitting information such like photography supporting information, use identification, or the like to the external apparatuses, an image editing section 103 for editing shot image information, and a registering section 104 for registering user information, image specifying information, or such. In FIG. 3, though external apparatuses are not shown, the external apparatus as shown in FIG. 1, which is the portable terminal 2, the communication device 4, or such, are also employed.

As shown in FIG. 4, the photography supporting server 1 may also employed, which includes the receiving section 101, the transmitting section 102, and the registering section 104. In FIG. 4, an image editing section is not incorporated in the photography supporting server 1. Therefore, as the external apparatus for transmitting/receiving information to/from the photography supporting server 1, an image editing device is employed instead.

The transmitting section 102 transmits the photography supporting information to the portable terminal 2 when the portable terminal 2 transmits a request for transmitting the photography supporting information, or the receiving section 101 receives the image specifying information. In other words, after such photography supporting information including a shooting instruction of either one place or one object has been transmitted, when a photograph is shot based upon the transmitted photography supporting information and the image specifying information for specifying a photograph is received, another photography supporting information for instructing either a next photograph place or a next photograph subject is transmitted. Basically, since photography supporting information to be transmitted is selected at random, photographs which are shot while users move through different routes from each other may be made different from each other.

The portable terminal 2 is, for instance, a portable telephone, and the photography supporting server 1 is capable of transmitting/receiving information via the communication line 8 with respect to the portable terminal 2. The portable terminal 2 receives photography supporting information from the photography supporting server 1, and outputs this received photography supporting information. As an output format of photography supporting information, such photography supporting information may be displayed on a display unit (not shown) of the portable terminal 2, or may be outputted to a user in the form of a speech signal. Also, while the portable terminal 2 is connected to the digital camera 3, this portable terminal 2 receives image specifying information for specifying a photograph shot by the digital camera 3, and then, transmits the received image specifying information via the communication line 8 to the photography supporting server 1. In the case that the portable terminal 2 includes the position detecting section, when image specifying information is transmitted to the photography supporting server 1, the portable terminal 2 may preferably transmit this image specifying information in combination with the positional information acquired by the position detecting function.

The digital camera 3 executes shooting operation of photographs, namely performs image shooting operation in response to photography supporting information received by the portable terminal 2. After image shooting operation is carried out, the digital camera 3 transmits image specifying information for specifying a photograph to the portable terminal 2, and then, this image specifying information is further transmitted to the photography supporting server 1. It should be understood that information may be transmitted/received between the digital camera 3 and the portable terminal 2 by employing a cable, or the like, or by using a short-distance wireless communication such as the Bluetooth®.

The communication device 4 is installed in a fixing manner at a plurality of suitable spots for shooting photographs within a photography supporting area where a photograph is shot based upon photography supporting information, for instance, such as a sightseeing spot, a so-called “Theme-park”, and a zoogical garden. The communication device 4 judges as to whether or not either the portable terminal 2 or the digital camera 3 is present in the vicinity of this communication device 4. In the case that either the portable terminal 2 or the digital camera 3 is present in the vicinity of the communication device 4, this communication device 4 transmits a presence sensing signal to the photography supporting server 1. The presence sensing operation by the communication device 4 can be carried out by executing a communication between either the portable terminal 2 or the digital camera 3 and the own communication device 4 by employing a short-distance radio communication such as the Bluetooth®.

While the communication device 4 is connected via a communication line to the photography supporting server 1, this communication device 4 transmits identification information of either the portable terminal 2 or the digital camera 3, which are present in the vicinity of the installation position of this communication device 4, to the photography supporting server 1. It should also be noted that when a gamely recreation is not strictly required for the photography supporting system, the communication device 4 may be omitted, since this communication device 4 is merely employed in order to confirm as to whether or not image information corresponds to such information which is acquired at a place where a photographing operation should be carried out based upon both the image specifying information transmitted from the portable terminal 2 and the photography supporting information transmitted from the photography supporting server 1.

The image editing device 5 edits shot image information of a photograph, which is shot based upon the photography supporting information, so as to create a image, such like a composite image including information relating to a location, time, shot object, or such. In the case that the shot image information is utilized as the image specifying information, the shot image information which should be edited is acquired from the photography supporting server 1. In the case that the supplemental information of the shot image information is utilized as the image specifying information, the shot image information which should be edited may be directly acquired from either a digital camera or an image recording medium of a user who uses this photography supporting system, or may be acquired via either a personal computer of a user (not shown) or a network. In this case, the acquired shot image information is utilized by being matched with the supplemental information which has been acquired as the image specifying information.

By editing the shot image information, the image editing device 5 creates an image related to the shooting location instructing information included in the photography supporting information, or an image related to the photograph subject instructing information. As one example, a composite image including the shot image information and a template image or text information, which are related to either the shooting location instructing information or the shooting object instructing information, may be employed. Also, as another example, while an area map of a photography supporting area where a photograph is shot based upon the photography supporting information is prepared, such a composite image may be employed which is formed by mapping a shot image information onto a position corresponding to the photography supporting information. Also, in the case that such hint information which indirectly indicates either a shooting location or a shooting object is utilized as the photography supporting information, such an image with which the image indicative of either the photograph point or the photographing subject has been synthesized-based upon the hint information may be employed as an edited image.

The edited image obtained by the image editing device 5 may be outputted as a photography print by the printer 6 so as to be supplied to the user. Also, an edited image may be supplied as a photography print, but also may be utilized in such recording media as a CD-ROM, and may be supplied as electronic information, for example, an edited image may be supplied as an upload service to an image storage server.

While the arrangement of the photography supporting system has been functionally explained, since the respective structural elements may be realized by employing the well-known structural elements, explanations of concrete structures thereof are omitted. As the digital camera 3, any one of such digital cameras having external connection interfaces may be properly selected. Also, as the portable terminal 2, any one of portable terminals having connection interfaces with the digital camera 3 may be properly selected. As to software of the photography supporting server 1, such software capable of realizing the above-described functions is developed. In this case, it is preferable to employ a user information file used to store thereinto information of a user, and a photography supporting information file used to store thereinto either a shooting location or a shooting object, which are transmitted as the photography supporting information.

As the image editing device 5, since various sorts of hardware and also various sorts of software have been marketed, any one of these hardware and software may be properly selected. In the image editing device 5, it is preferable to prepare such a template image file into which template image information corresponding to the photography supporting information has been stored. It should be noted that in the photography supporting system of FIG. 1, the photography supporting server 1 and the image editing device 5 are described as the separate apparatus. The image editing device 5 may also be incorporated in the photography supporting server 1 as an image editing section. Alternatively, while two sets of the hardware are commonly used, images may be edited by the photography supporting server 1.

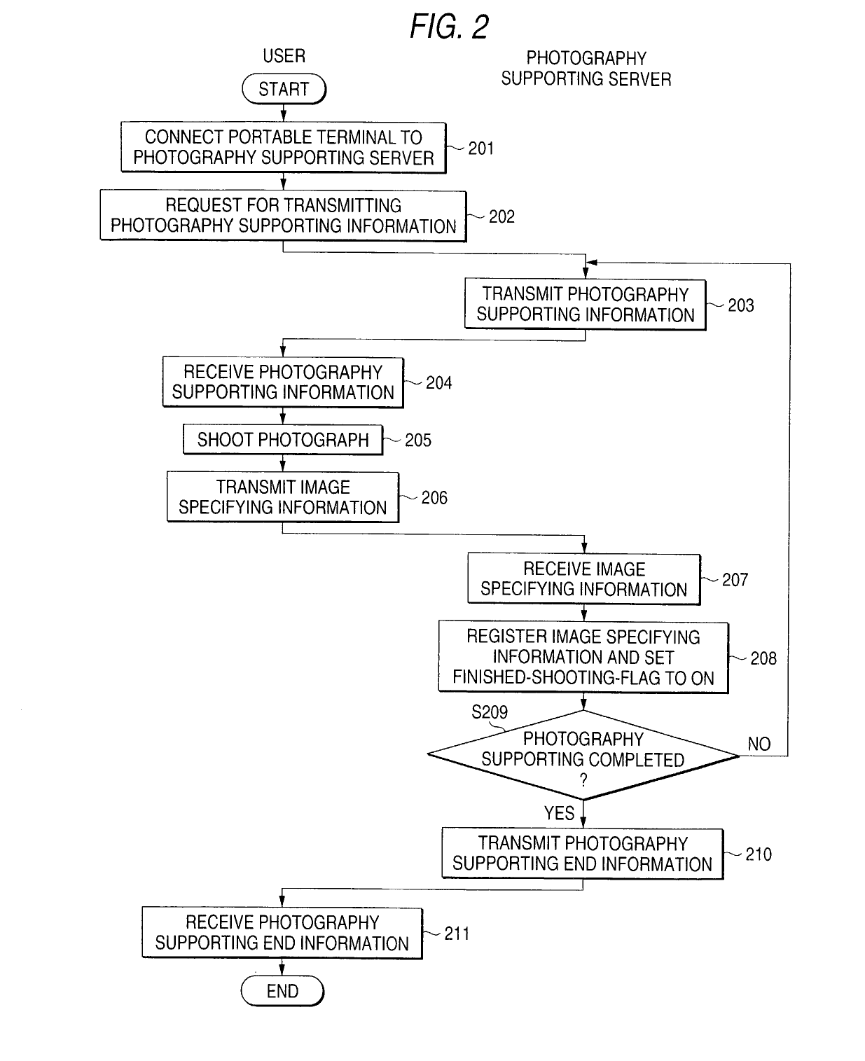

Next, photographing operations executed by using this photography supporting system will now be explained with reference to an operation flow chart of FIG. 2. It is so assumed that the communication device 4 is not installed while the operations of the flow chart shown in FIG. 2 are explained. Also, it is so assumed that while users have been previously registered, information (name of user, ID of portable terminal) related to the users has been stored in the user file of the photography supporting server 1.

A user who tries to receive a photograph supporting service at a sightseeing spot, a so-called “Theme-park”, a zoogical garden, and the like, is connected to the photography supporting server 1 by the portable terminal 2 (step 201), and then receives a user identification transmitted from the transmitting section of the photography supporting server 1. In this case, since the user information has been registered in the user file by the registering section 104, this user can receive the service. When the user information has not yet been registered, the user registration may be performed at this stage by employing the portable terminal 2. Alternatively, a user may be registered by an information office of a sightseeing spot, a so-called “Theme-park”, a zoogical garden, and the like.

After the user identification is accomplished, the user issues a request for transmitting the photography supporting information against the photography supporting server 1 in a step 202. In such a case that the photography supporting server 1 executes photograph supporting operations as to a plurality of photograph supporting areas (for instance, a plurality of sightseeing spots, a plurality of so-called “Theme-parks”, a plurality of zoogical gardens etc.), the user selects an area where a photography supporting service is wanted to be received. Also, in the case that the photography supporting server 1 executes an editing service of a shot photograph, the user selects a sort (sort of edited image, output format, etc.) of editing service.

When the transmission request of the photography supporting information is issued, the photography supporting server 1 extracts photography supporting information of the selected photograph supporting area from the photography supporting information file at random, and then, transmits the extracted photography supporting information to the portable terminal 2 (step 203). It should be also understood that when the photography supporting area is wide, a present position of a user may be detected, or may be entered, and then, the photography supporting server 1 may select the photography supporting information from plural sets of photography supporting information at random, which are selected in response to the present position of the user. In this case, the photography supporting information to be transmitted may be given as follows: That is to say, for instance, “to shoot a photograph of lake “C” from place “A” in direction of “B” (in case of sightseeing spot)”, “to shoot a photograph of “Y” located around place “X” (in case of so-called “Theme-park”)”, and “to shoot a photograph of “the king of beasts” (in case of zoogical garden)”, and the like. The photography supporting information may be realized by way of electronic information such as text information and image information, or speech information. Also, the plural sets of photography supporting information which have been transmitted are managed differently at each user.

Upon receipt of the photography supporting information (step 204), the portable terminal 2 displays the photography supporting information (in case of electronic information), or outputs speech. It is preferable that the received photography supporting information is held by the portable terminal 2, and this received photography supporting information may be outputted if necessary. Next, the user moves to a photograph place in accordance with the photography supporting information, and then, photographs a photographing subject instructed by the photography supporting information (step 205). A total sheet of images to be photographed may be arbitrarily selected. After the photographing operation has been accomplished, the portable terminal 2 transmits image specifying information used to specify a photographed image, for instance, transmits photographed image information (step 206). In order to transmit the photographed image information, such image information to be transmitted is selected by the digital camera 3, the digital camera 3 is connected to the portable terminal 2, and then, the portable terminal 2 is connected to the photography supporting server 1.

When the image specifying information is received in a step 207, the registering section 104 of the photographing server 1 registers the received image specifying information in correspondence with the photography supporting information of each user, and further, sets a finished-shooting-flag of the photography supporting information to ON state(step 208). Then, the photography supporting server 1 judges as to whether or not the photograph supporting operation is accomplished in a step 209. When the photography supporting server 1 judges that this photograph supporting operation is not yet accomplished, the process operation is returned to the previous step 203 in which a similar process operation is repeatedly carried out. The photography supporting server 1 may judge as to whether or not the photograph supporting operation is accomplished by checking as to whether or not the photography supporting information to be transmitted is present, and/or by checking as to whether or not a photograph supporting end request signal is issued from the user. The photograph supporting end request signal issued from the user may be preferably added when the image specifying information is transmitted in the step 206.

In the case that the process operation is returned to the step 203 in which the photography supporting server 1 transmits new photography supporting information, this photography supporting server 1 transmits such a photography supporting information which is selected at random from plural sets of the photography supporting information which have not yet transmitted. Also, in this case, the photography supporting server 1 may select at random such a photography supporting information from the photography supporting information selected in response to the present position. In the case that the photography supporting server 1 judges that the photography supporting operation is completed in the step 209, this photography supporting server 1 transmits photography supporting end information to the portable terminal 2 (step 210). Then, the portable terminal 2 receives this photograph supporting end information to the portable terminal 2 (step 211), and then, the process operation is ended. Thereafter, the portable terminal receives an output of an edited image by using the photographed image, if required. A printed image may be received at an information office, or may be received by a delivery service.

As apparent from the foregoing descriptions, in accordance with the present invention, it is possible to provide such a photography supporting system capable of performing the photograph supporting operations as to a plurality of photograph points, or a plurality of photographing subjects, while the game nature is added thereto. Also, according to the present invention, it is possible to provide another photography supporting system capable of simply acquiring the edited images of the plural photographed images within a short time.

What is claimed is:

1. A photography supporting system for supporting to shoot a photograph by using photography supporting information transmitted via a communication line, the system comprising:
a photography supporting server connected to the communication line; and
a portable terminal, which is connectable to a digital camera and capable of transmitting/receiving information via the communication line with respect to the photography supporting server;
wherein the photography supporting information includes at least one of shooting location instructing information and shooting object instructing information,
wherein the photography supporting server transmits the photography supporting information to the portable terminal, when the photography supporting server receives a request for transmitting the photography supporting information from the portable terminal, or image specifying information transmitted from the portable terminal,
wherein the image specifying information is used for specifying a photograph shot by the digital camera and is obtained from the digital camera connected to the portable terminal.

2. The photography supporting system according to claim 1,
wherein the image specifying information corresponds to shot image information of a photograph shot by the digital camera.

3. The photography supporting system according to claim 1,
wherein the image specifying information corresponds to supplemental information of the shot image information of a photograph shot by the digital camera.

4. The photography supporting system according to claim 3,
wherein the supplemental information includes shooting location information.

5. The photography supporting system according to claim 1,
wherein the portable terminal includes a position detecting section for obtaining positional information by detecting a position where the portable terminal is located, and transmits the image specifying information in combination with the positional information obtained by the position detecting section to the photography supporting sever.

6. The photography supporting system according to claim 1, further comprising:
a plurality of communication devices installed at a plurality of places within a photography supporting area where photographs are shot based upon the photography supporting information;
wherein the communication device senses presence of either the portable terminal or the digital camera, and transmits a presence of sensing signal to the photography supporting server when presence of the portable terminal, or the digital camera is sensed, and
wherein the photography supporting server transmits the photography supporting information to the portable terminal when the photography supporting server receives both the image specifying information and the presence sensing signal.

7. The photography supporting system according to claim 1, further comprising:
an image editing device for editing shot image information of a photograph shot based upon the photography supporting information and creating a composite image;
wherein the composite image is composed of the shot image information and the shooting location instructing information included in the photography supporting information, image information related to the shooting object instructing information, or text information related to the shooting object instructing information.

8. The photography supporting system according to claim 7,
wherein the image editing device creates a composite image by mapping an image included in the shot image information onto a position corresponding to the photography supporting information within an area map, and
wherein the area map covers the photography supporting area where photographs are shot based upon the photography supporting information.

9. The photography supporting system according to claim 7,
wherein the photography supporting information corresponds to hint information which indirectly indicates either a shooting location or a shooting object, and
wherein the composite image obtained by the image editing device includes information indicative of either a shooting location or a shooting object based upon the hint information.

10. The photography supporting system according to claim 7,
wherein the photography supporting server includes the image editing device.

11. A photography supporting server for transmitting photography supporting information via a communication line to a portable terminal, the server comprising:
a receiving section for receiving a request for transmitting photography supporting information from the portable terminal, or image specifying information for specifying a photograph shot by the digital camera via the portable terminal; and
a transmitting section for transmitting the photography supporting information to the portable terminal when the photography supporting server receives the request for transmitting photography supporting information or the image specifying information;
wherein the portable terminal is connectable to a digital camera, and
wherein the photography supporting information includes at least one of shooting location instructing information and shooting object instructing information.

12. The photography supporting server according to claim 11,
wherein the image specifying information corresponds to shot image information of a photograph shot by the digital camera.

13. The photography supporting server according to claim 11,
wherein the image specifying information corresponds to supplemental information of the shot image information of a photograph shot by the digital camera.

14. The photography supporting server according to claim 13,
wherein the supplemental information includes shooting location information.

15. The photography supporting server according to claim 11,
wherein the portable terminal includes a position detecting section for obtaining positional information by detecting a position where the portable terminal is located, and
wherein the receiving section of the photography supporting server receives the positional information in combination with the specifying image information.

16. The photography supporting server according to claim 11,
wherein the receiving section further receives presence sensing signals from a plurality of communication devices,
wherein the transmitting section further transmits the presence sensing signals to the portable terminal, and if the image specifying information is received, transmits the photography supporting information to the portable terminal together with the presence sensing signals, and
wherein the communication devices are installed at a plurality of places within a photography supporting area where a photograph is shot based upon the photography supporting information.

17. The photography supporting server according to claim 11, further comprising:
an image editing section for editing shot image information of a photograph shot based upon the photography supporting information and creating a composite image;
wherein the composite image includes the shot image information and an image information related to the shooting location instructing information or the shooting object instructing information, or text information related to the shooting location instructing information or the shooting object instructing information.

18. The photography supporting server according to claim 17,
wherein the image editing section creates a composite image by mapping an image included in the shot image information onto a position corresponding to the photography supporting information within an area map, and
wherein the area map covers the photography supporting area where photographs are shot based upon the photography supporting information.

19. The photography supporting server according to claim 17,
wherein the photography supporting information corresponds to hint information which indirectly indicates either a shooting location or a shooting object, and
wherein the image editing section creates a composite image including the shot image information and image information included in the hint information and related to the shooting location or shooting object, or text information included in the hint information and related to the shooting location of shooting object.
